(19) United States
(12) Patent Application Publication
(10) Pub. No.: US 2002/0078192 A1
(43) Pub. Date: Jun. 20, 2002

(54) Cookie manager for control of cookie transfer in internet client-server computer systems

(76) Inventors: Stefan Kopsell, Dresden (DE); Oliver Berthold, Dresden (DE)

Correspondence Address: Scully, Scott, Murphy & Presser, 400 Garden City Plaza, Garden City, NY, 11530, US

(21) Appl. No.: 09/919,718

(22) Filed: Aug. 1, 2001

(30) Foreign Application Priority Data
Aug. 1, 2000 (EP) 00 116 634.7

(51) Int. Cl. G06F 15/173; G06F 15/16

(52) U.S. Cl. 709/223; 709/218

(57) ABSTRACT

The present invention relates to method of and a computer software product for administering cookies in an Internet client-service system in which cookies are exchanged between a server computer (17) and a client computer (11) via the Internet (16), wherein the return of a cookie, stored in a client computer (11), to the server computer (17) which placed the cookie, is dependent upon a preceding check of the cookie. There is further proposed a client computer (11) for an Internet client-server system, having an interface device for data exchange via the Internet, at least one memory device (13) for storing data objects and an administration means for administering cookies, wherein the administration means (14) sends a cookie stored in the memory device (13) back to the server computer (17) which placed the cookie, in dependence upon a preceding checking.

The present invention makes it possible for a user in the Internet to control cookie transfer to and from his client computer in an advantageous manner.

The invention relates to communication in client-server computer systems, in particular in the Internet, in which a server computer sends status information to a client computer in the form of a cookie, which the client computer stores for later return to the server computer, and wherein there are applied methods for recording the use of a downloaded resource and the actions effected on this by the user of the client computer.

The World Wide Web (web) is the most widespread information system in the Internet. The architecture of the web is based on a conventional client-server model, whereby the term client or client computer relates to the general role of a computer as a requester of data, and the term server or server computer relates to the general role of a computer as a provider of data in a network. On the client side, a web browser (browser) enables access to the web and to the documents located on the server computers or web servers of the web. A client computer (web client) connected to the web communicates with a server computer by means of the “Hyper Text Transfer Protocol” (HTTP). A browser opens a connection to a server computer and starts a request for a document. The server computer delivers the requested document typically in the format of a text document (web page) coded in “Hyper Text Markup Language” (HTML). After closing of the connection, the server computer remains passive, i.e. it cannot itself require the web client to carry out further action. Thus, the possibilities for interactive communication between server and client in the web are restricted. However, since the end of 1994, a mechanism has existed which allows processes on the server side to store, and also to call up, information on the client side. This mechanism is described in U.S. Pat. No. 5,774,670. For this purpose, one or more items of status information of the HTTP answer of the server are placed in front in the form of a document header. These items of status information are generally called a cookie. If the user of a client computer, in the following called a web user or user, starts a request to a server computer of a particular domain, beforehand the cookies present on the client computer are checked as to whether they belong to this domain and, if appropriate, sent with the request to the server computer.

An HTML document may contain elements which are constituted only as a reference to an associated resource which is located on a different server computer. If a web site configured in this way is called up by the user further documents are requested from this and/or other server computers, automatically without the user having influence on this, whereby the elements provided as a reference in the original HTML document are completed. Thereby, server computers to which connection was established mediated via a reference in the originally requested web page can likewise transfer cookies to the client. With this, the user looses control over from which server computers and for what purposes cookies may be sent to his computer, in particular since the transfer and storing of the cookies is not visible for the user.

This property of the cookie mechanism can be used in the Internet for the collection of identity-related information. Thus, for example, the path of a user through the web pages of a particular domain and his behaviour therein can be tracked and recorded. The items of information obtained in this way can be evaluated in part for a user-specific automatic adaptation of the starting page or also of the services offered. This makes it possible for example for an investment adviser to present each of his customers with the prices of the shares in which the customer concerned has shown particular interest in the past, on the first page. Further, e-commerce methods are based on the cookie mechanism. Thereby, for each item placed in the shopping basket, a cookie is sent to the client computer and as soon as the order is to be issued, all these cookies are sent back to the server computer of the offerer of the items and evaluated for the processing of the order.

Since cookies are only sent back to the domains from which they were sent to the client computer, this process gives the user the impression of a certain degree of trustworthiness, which is not justified since as shown the user has no control over the domains from which he receives cookies. Advertising groups for example place their advertising banners on many popular pages of the Internet in accordance with the above-described method. This means that the central server of an advertising group is now addressed, and can send cookies to the client computer, from many different web pages. With each call of a web page having an advertising banner of this advertising group there thus follows a request to the domain of the central advertising server, with which cookies already earlier sent therefrom are returned thereto before a new cookie is, possibly, again transferred to the client computer with the advertising banner. The contents of the cookies sent are stored in a data bank of the advertising group and a profile of the user produced therefrom. With time, these profiles form a meaningful pattern of the activities of the user in the Internet, from which the habits and preferences of the user can be deduced. From these profiles, as disclosed in U.S. Pat. No. 5,991,735 and U.S. Pat. No. 5,918,014, demographic and psychographic information concerning the users can be derived, on which further actions of the advertising group are based, such as e.g. user-specific offers or user-specific advertisements. The more different Internet pages that have an advertising banner of a particular advertising group, the better can the movements of the user in the Internet be tracked, and the more comprehensive will be the information collected about him. With this, the psychogram of the user can be defined ever more exactly and naturally also more personally.

Although the usual browsers offer the possibility of configuring behaviour in relation to the cookie mechanism, this can only be done to a very restricted extent. In particular they offer no possibility of configuring the exchange of cookies to be transparent. The cookie mechanism can be deactivated,- but if this is done for example a movement in domains having restricted access and also e-commerce is prevented. In particular, the possibilities offered by browser settings do not allow a distinction to be made between a transfer of desired or undesired cookies.

It is thus the object of the present invention to remedy the above-mentioned disadvantages of the state of the art, and to make it possible for a user in the Internet to control cookie transfer from and to his client computer without him having to do without certain of the services offered via the Internet. In particular it is also an object of the present invention to make it possible for a user in the Internet to avoid the collection of identity-related information.

The object is achieved by means of a method of administering cookies in an Internet client-server system, in which cookies are exchanged per Internet between a server computer and a client computer, in which the return to the server computer of a cookie stored in the client computer, which server computer had put of the cookie in place, is dependent upon preceding check of the cookie.

Further, the object is achieved by means of a computer software product for the administration of cookies in an Internet client-server system, in which cookies are exchanged per Internet between a server computer and a client computer, whereby the return of a cookie stored in a client computer to the server computer which put the cookie in place is allowed in dependence upon a preceding check of the cookie.

Further, the object is achieved by means of a client computer for an Internet client-server system, having an interface device for data exchange via the Internet, at least one memory device for storing data objects, and an administration means for the administration of cookies, whereby the administration means sends back a cookie stored in the memory device to the server computer which put the cookie in place, in dependence upon a preceding check.

Advantageous developments are indicated in the respective subclaims.

In accordance with a preferred configuration, the administration and checking of cookies stored and to be stored on the client computer is effected independently of a browser of the client computer which establishes an Internet connection to a server computer. In a further preferred configuration a checking of a cookie to the sent back can be effected in dependence upon a configurable set of conditions in the client computer. Further, it is particularly advantageous to determine the result of the checking of a cookie in dependence upon an evaluation of the server computer address associated with the cookie as desirable or undesirable, whereby directly selected addresses can be set as desirable, and indirectly selected addresses as undesirable.

In accordance with a particularly advantageous configuration of the invention, the format of a cookie stored in a client computer includes a first data set having data fields for holding the original data of the cookie, and a second data set having data fields for holding additional data which serves for the checking of the cookie. Advantageously thereby, the second data set may include a first data sub-set having data fields for holding the date of creation of the cookie and/or the designation of the cookie and/or the description of the cookie and/or classifying keywords, whereby in a further advantageous configuration there is added to the second data set of a cookie valid for a request made by a browser a further data sub-set having information for classification and protocolling of the request. Thereby it is of particular advantage when the added further data sub-set contains at least the name and Internet address of the HTML page directly called up on which the object was located which initiated the request, and the time point of the call.

In a further configuration, each cookie or a collection of a plurality of cookies can be stored in separate files in the client computer. In a further advantageous configuration of the present invention these files are transferred to and from at least one further computer, so that a client computer has available to it a plurality of different cookies valid for one server computer address. In particular, in accordance with a particularly advantageous configuration, different client computer cookies can be stored in, searched and called up from data banks of different Internet server computers, so that there are available on a client computer a plurality of different cookies valid for one server computer address, whereby in accordance with a further configuration of the invention advantageously the selection of a cookie to be sent back is effected randomly from a plurality of cookies valid for this request.

The advantages of the present invention are on the one hand the control of cookie transfer via Internet connections by the user which is made possible thereby, and on the other hand to make the return of the cookies dependent upon evaluation criteria which can be configured. Further, the recording of data for the description of the cookie and the initiator of its sending, together with the subsequent recording of the further use of the cookie has the advantage that it can be made transparent to the user on which server computers what kind of data is collected about him. The exchange of cookies between the individual client computers in accordance with the invention makes it possible for the user to return to selected server computers, alternatively to “his” cookies, foreign cookies selected randomly, so that the data collected about him is made valueless, whereby above all the employment of cookie servers for the automatic organisation of the exchange of cookies for this purpose creates a world wide basis, extending far beyond the circle of acquaintances of one person.

In the following, the present invention will be described in more detail with reference to the accompanying drawings, in which there is shown:

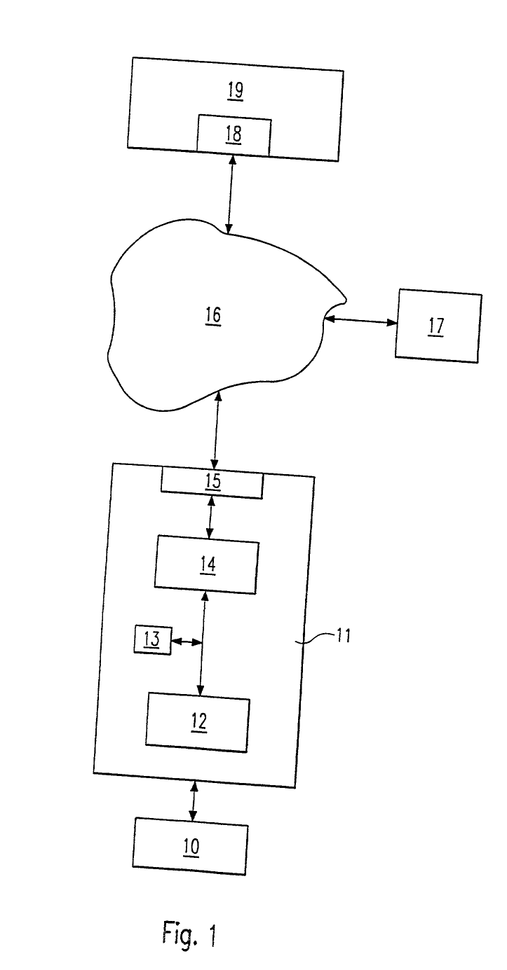

FIG. 1 schematically an Internet client-server system in which the present invention is realised,

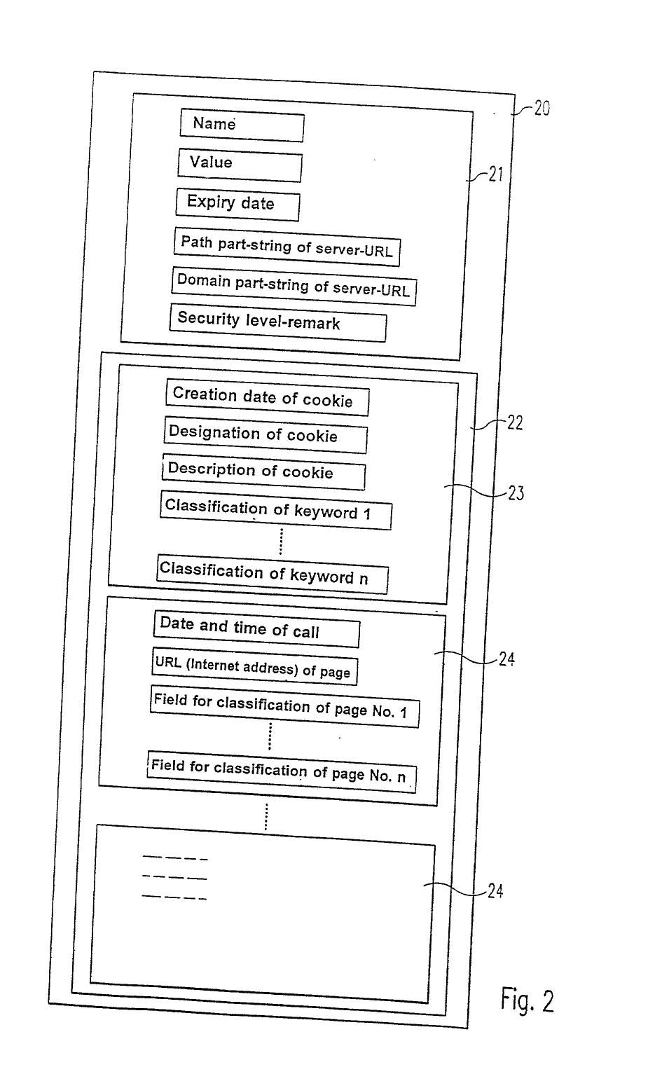

FIG. 2 a schematic diagram of a cookie format in accordance with the present invention,

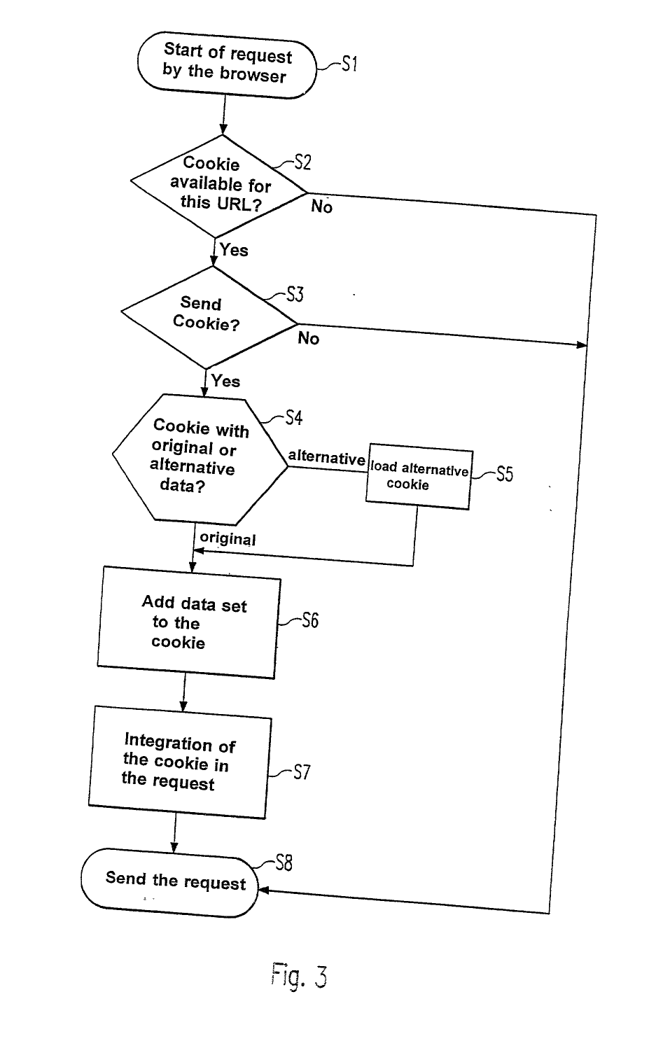

FIG. 3 a flow diagram for explanation of the method of administration of cookies in accordance with the invention,

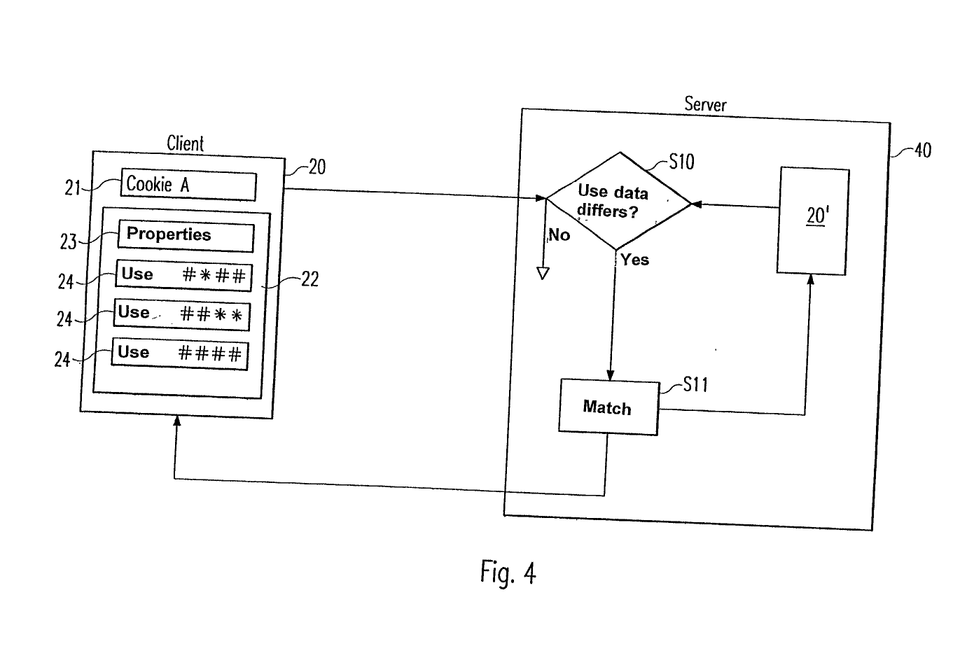

FIG. 4 a schematic for illustrating the synchronisation of data between a cookie manager and a cookie server corresponding to a further preferred configuration of the invention.

FIG. 1 shows schematically an Internet client-server system for explanation of the establishment of a connection of a user in the Internet to a server computer in accordance with the present invention. A user 10 establishes with the aid of the web browser 12 installed on his client computer 11 a connection with a server computer 17 via the Internet 16. In accordance with the present invention there is found on the client a computer software product 14, called a cookie manager in the following, which is connected in the flow of data between the browser and the Internet. This cookie manager analyses all data going out from the browser and all data coming in from the Internet. If a document sent from the Internet contains a cookie this is filtered out by the cookie manager and not passed on to the browser. In dependence upon the configuration effected by the user, the cookie is, if applicable, stored or otherwise is removed. The basis for this decision is an evaluation of the cookie as desired or undesired. This is determined on the basis of the address which sent the cookie, so that the criterium for the evaluation of the cookie reduces to whether it was sent from a desired address or from an undesired address.

If one assumes that the user requests documents via the Internet in accordance with his desires and inclinations, requests which are directly caused through his actions can be considered as desired requests, whilst requests which are indirectly caused by his actions, such as for example the subsequent loading of elements or object contents of the web page called up by him, can be considered as undesired. In order to recognise whether a cookie was sent by a request caused directly by a user action or was sent indirectly due to the subsequent loading of elements to the client, it may be advantageous to integrate a part of the cookie manager in the browser program. With a different configuration of the cookie manager, independent of the browser program of the client, the cookie manager detects the address of the first request from the user and stores this as desired address. If now a cookie is returned to the client from the server computer having this first address, the cookie is considered to be desired and stored on the client computer. All further requests automatically following this first request directly initiated by the user, likewise cookies possibly sent from these addresses, are considered as undesired. In a further advantageous configuration of the present invention it is checked whether the target of the request is a normal HTML page or an embedded object, which normally is automatically subsequently loaded. In the first case the cookie sent from the address is evaluated as “desired” and the second case as “undesired”.

The evaluation of a cookie can also be effected via the identification of the types of the objects to be loaded. On the one hand, for this purpose the file name extension of the object to be loaded can be employed, and on the other hand a content type made available by the HTML standard. Since, however, the content type is only contained in the answer from the server, a corresponding entry in the second data set of the cookie is effected only after reception of the HTML page.

For the reliable recognition of the originally called-up page, additionally three special cases must be distinguished and recognised. If a server has changed its address, there may be connected at the old address a web page which directs the browser automatically to call up the new address. This process, called re-direct, is recognised by the cookie manager and the new address of the server computer is entered in the use data set 24 (FIG. 2). If the web page called-up consists of a plurality of partial windows, so-called frames, through the request of the user only one page is called up which then contains the loading commands for the further pages which are loaded into the respective frames. The cookie manager recognises this special form of follow-up call and enters the loading command for the originally loaded page in the use data set 24 (FIG. 2) of the cookie. By the employment of active contents, the server computer can cause the browser to load additional objects either through actions of the user or automatically. If the loading of the object is caused by an input of the user, the address of the object is entered in the use data set of the cookie. If, however, active influence of the user cannot be determined, and/or if the object is automatically loaded, in these two latter cases the address of the originally called-up page is entered in the use data set of the cookie. The decision criterium is based on the assumption that as a rule user actions are initiated by clicking on a link, i.e. by a reference to another page. Actions of the user can now furthermore be subject to verification as to whether the address of the request was contained as a link on a preceding page. If the user enters the address directly, the HTTP header line “referrer” is not present as in the preceding case. The entry in the “referrer” can thus be employed as a decision criterium.

If the cookie manager finds a cookie in the incoming data flow this is, so far as permitted by the configuration effected by the user, stored. The storing is effected in the cookie format 20 illustrated in FIG. 2. This format is made up of three different data sets, whereby the first data set 21 contains the original data of the cookie as it was sent from the server computer to the client computer. This is followed by a data set 22, the first data sub-set 23 of which contains data fields relating to the properties of the cookie. This is followed by data sets 24, which characterise the use of the cookie in the course of its employment. The original data set 21 contains data fields for holding the name and the value of the cookie, those two elements of the cookie which upon request are sent back to the server computer which put the cookie in place. Further data fields contain the expiry date of the cookie, the path part-string and the domain part-spring of the server computer address and a remark whether the return of the cookie should be effected via a secure connection to the server computer. The data set 23, which describes the properties of the cookie, includes data fields for holding the creation date, a designation, a description and a plurality of data fields which can hold keywords for classification of the cookie. If a request is directed via the Internet to a server computer address for which a cookie is present on the client, and if this is permitted by the configuration set up by the user, cookies valid for this address are sent back to the server computer. In this case the cookie, stored by the cookie server in the above-described format, has added thereto a new use data set 24 in the data fields of which the date and time of the call and the Internet address URL of the called-up page are contained and a plurality of data fields with classification information concerning the called-up page. In the case of repeated employment of the cookie there is again added a further use data set 24, so that the sum of the use data sets serves as a record of employment of the cookie, or can be evaluated as a source of information concerning the information which has been collected about the user.

For classification of the called-up page the data fields may contain the result of the above-described determination or checking whether this is a desired or undesired address. In general the entry in the referrer can also be contained in one of these data fields for determining the page actually called-up.

FIG. 3 shows the effect of the cookie manager on the cookie mechanism in the case of a request of the browser to a server computer. If the browser starts a request to the Internet in a step Si, the cookie manager checks in a step S2 whether a valid cookie is available for the requested address. If this is not the case, the request is passed on to the Internet in a step S8. If a cookie is available, in a step S3 the configuration set by the user is checked, and possibly the user is directly queried. If the result of the check is negative, the processing branches to step S8 and the request of the browser is passed on to the Internet without a cookie being appended. If the result of the checking was positive, it is determined in a step S4 whether the original cookie or an alternative cookie with misleading information should be employed, which in this case is loaded in a step 5. In both cases, in a subsequent step S6, there is added to the cookie format a further use data set 24, and finally in a step S7 the name and value of the cookie is integrated in the request of the browser and in step S8 passed on to the Internet.

If the user configuration is restricted only such that no cookie is to be sent to an undesired address, this solely has the consequence that the operators of centralised data banks for the collection of identity-related information can receive no further information about the user. Information already collected remains, however, authentic. The monitoring of the user, illegal in many countries, can however be best countered in that deliberately misleading information is fed into these central data banks. The operators of advertising servers assume that each cookie is stored only on exactly one computer. In other words, if a server computer receives a cookie together with a request, it assumes that it reflects the identity of the user. If, instead, there is returned a cookie with the identity for another user, the data set in the central data bank for the collection of identity-related information becomes unusable. Further, for the operator of such a data bank, it is not directly recognisable which entries in his data bank have been made misleading. In the case of a widespread use of the cookie manager, the entire data bank of the operator would be made virtually worthless, since potentially every entry could be misleading. In order to make this possible, in a further configuration of the present invention, the possibilities of configuration by the user are so extended that if he for example wishes to be recognised as a user with very particular characteristics, he allows the data of the original cookie to be send back to the server computer or in the case of an undesired address he can indicate whether for this connection no cookie should be returned or a suitably randomly chosen cookie of another user should be returned.

The cookie manager administers the cookies such that for each address of a server computer an arbitrary number of cookies can be alternatively used. Thereby the use of cookies of different clients is effected through random choice via an import and export interface of the cookie manager. Each cookie or a collection of many cookies can be stored in external files and thus easily transferred to other computers. The transfer may be effected e.g. by e-mail or via the computer of a local area network LAN. In accordance with a particularly advantageous configuration of the present invention, the exchange of cookies can be effected via so-called cookie servers, by which means cookies can be exchanged worldwide, beyond the circle of acquaintances of one person. By a cookie server there is to be understood a computer which is connected to the Internet and receives cookies from cookie managers and returns alternative cookies to these cookie managers.

These uploads and downloads may thereby be effected directly between the individual cookie managers and the cookie server or servers via a special Internet interface 15, 18. The cookies received in the above-described format from the cookie manager are saved on the cookie server in a data bank. Search functions defined on this data bank make possible a targeted selection of cookies with particular characteristics and the automatic downloading of cookies for the connection with a particular server computer. So that operators of central data banks for the collection of identity-related data cannot efficiently query the cookie server, in order for example to be able to identify misleading data entries in their data bank, no search functions relating to the cookie name and/or the cookie values are present on the cookie server. Further, a cookie is only passed on to a restricted number of users; if this number is exceeded, the cookie is either deleted or blocked. This prevents a server computer from recognising its' cookies and reacting appropriately. For this reason, in a particularly advantageous configuration of the present invention, a plurality of independent, at least in part not publicly known cookie servers, deal with the exchange of alternative cookies. The individual cookies are held on a cookie server only for a restricted span of time and after expiry thereof deleted. By these means it is ensured that no information concerning individual users could collect on a cookie server, in particular also in that each cookie manager exchanges its cookies with a series of servers, and thus each cookie server holds only a fraction of the use data.

The protection of user information can be achieved in a further configuration of the present invention in that each cookie manager is so configured that only an arbitrary portion of the fields in the use data set is transferred to the cookie servers, so that a user is not compelled to pass on his use data to a cookie server which for him is perhaps not completely trustworthy. In order to ensure the trustworthiness of a cookie server, this should authenticate itself with the employment of digital certificates, for the cookie manager. A further possibility for the protection of user data, which can also be employed in addition to what is described above, is access to the cookie server via anonymiser services. Since most available anonymiser services work on the basis of the worldwide web or e-mail, the Internet interface should be so designed that it can be tunnelled using these protocols.

If a cookie is simultaneously stored in many cookie managers, naturally in each case only the locally arising use data 24 is added. In other words, the same cookies manifest, due to their employment on different clients, different use data sets, and thereby only an incomplete image of their complete employment. In order to complete the protocolling of the employment of a cookie, the cookie server has the possibility for synchronising the data. The corresponding synchronisation mechanisms are supported both by the cookie managers and also by the cookie servers. Also special Internet interface 15, 18 via which the exchange of the cookies is effected between the cookie managers and the cookie servers, supports corresponding functions of the synchronisation mechanism.

In FIG. 4 there is illustrated the case in which a cookie manager transfers a cookie 20 to a cookie server 40 and in the reply of the cookie server to the cookie manager the data sets not yet contained in this cookie are send back. In order to determine these data sets, the synchronisation mechanism of the cookie server compares in a first step S10 the use data sets of the cookie 20 transferred from the cookie manager with those of the cookie 20′ present on the server and forms, if the two use data sets are different, in a synchronisation step S11 the sum of both use data sets and removes from this sum of the use data sets which were already contained in the cookie transferred from the cookie manager. The user thus obtains a comprehensive overview of the employment of the corresponding cookie. By the alternative employment of randomly selected cookies of others users throughout the world, the user profiles in data banks for storing identity-related information on the corresponding Internet server computers are mixed in such a manner that the operators of such data banks cannot recognised misleading data entries and the stored data is thus potentially valueless for them.

1. Method of administering cookies in an Internet client-service system in which cookies are exchanged between a server computer (17) and a client computer (11) via the Internet (16),
characterised in that,
the return of a cookie, stored in a client computer (11), to the server computer (17) which placed the cookie, is effected in dependence upon a preceding check of the cookie.

2. Method of administering cookies in an Internet client-server system in accordance with claim 1,
characterised in that,
the administration and checking of cookies stored and to be stored on a client computer is effected independently of a browser (12) of the client computer which establishes an Internet connection to a server computer.

3. Method of administering cookies in an Internet client-server system in accordance with claim 1 or 2,
characterised in that,
the checking of a cookie to be returned is effected in dependence upon of configurable evaluation criteria in the client computer.

4. Method of administering cookies in an Internet client-server system in accordance with any of claims 1 to 3,
characterised in that,
the result of the checking of a cookie is determined in dependence upon an evaluation of the server computer address which is attributed to this cookie as desired or undesired, directly called-up addresses being regarded as desired, indirectly called-up addresses as undesired.

5. Method of administering cookies in an Internet client-server system in accordance with any of claims 1 or 4,
characterised in that,
the format (20) of a cookie stored in a client computer includes a first data set (21) having data fields for holding the original data of the cookie and a second data set (22) having data fields for holding additional data which serve for the checking of the cookie.

6. Method of administering cookies in an Internet client-server system according to claim 5,
characterised in that,
the second data set (22) includes a first data sub-set (23) having data fields for holding the date of creation of the cookie and/or the designation of the cookie and/or the description of the cookie and/or classifying keywords.

7. Method of administrating cookies in an Internet client-server system according to claim 5 or 6,
characterised in that,
there is added to the second data set (22) of a cookie valid for a request made by a browser (12) a further data sub-set (24) having information for the classification and protocolling of the request.

8. Method of administering cookies in an Internet client-server system according to claim 7,
characterised in that,
the added further sub-set (24) includes at least the name and the Internet address of the directly called-up HTML page on which the object was located which initiated the request, and the time point of the call.

9. Method of administering cookies in an Internet client-server system according to any of claims 5 to 8,
characterised in that,
each cookie or a collection of a plurality of cookies are stored in separate files in the client computer (11).

10. Method of administering cookies in an Internet client-server system according to claim 9,
characterised in that,
these files are transferred to and from at least one further computer, so that a client computer (11) has available a plurality of different cookies valid for one server computer address.

11. Method of administering cookies in an Internet client-server system according to claim 10,
characterised in that,
different client computers (11) store, search and call-up cookies in data banks from different Internet server computers (19), so that on one client computer (11) there are available a plurality of different cookies valid for one server computer address.

12. Method of administering cookies in an Internet client-server system according to claim 10 or 11,
characterised in that,
the selection of a cookie to be sent back is effected randomly from amongst a plurality of cookies valid for this request.

13. Computer software product for administering cookies in an Internet client-server system, in which cookies are exchanged between a server computer (17) and a client computer (11) via the Internet (16),
characterised in that,
it allows a return of a cookie stored in a client computer (11) to the server computer (17) which placed the cookie, in dependence upon a preceding check of the cookie.

14. Computer software product for administering cookies in an Internet client-server system according to claim 13,
characterised in that,
it administers and checks- cookies stored and to be stored on a client computer independently of a browser (12) of the client computer which establishes an Internet connection to a server computer.

15. Computer software product for administering cookies in an Internet client-server system according to claim 13 or 14,
characterised in that,
it undertakes a check of the cookie to be sent back in dependence upon configurable evaluation criteria in the client computer.

16. Computer software product for administering cookies in an Internet client-server system according to any of claims 13 to 15,
characterised in that,
it determines the result of the checking of a cookie in dependence upon an evaluation of the server computer address which is attributed to this cookie as desired or undesired, directly called-up addresses being regarded as desired, indirectly called-up addresses as undesired.

17. Computer software product for administering cookies in an Internet client-server system according to any of claims 13 to 16,
characterised in that,
it stores a cookie in a client computer in a format (10) comprising a first data set (21) having data fields for holding the original data of the cookie and a second data set (22) having data fields for holding additional data which serves for the checking of the cookie.

18. Computer software product for administering cookies in an Internet client-server system according to claim 17,
characterised in that,
it makes available in the second data set (22) a first data sub-set (23) having data fields for holding the creation date of the cookie and/or the designation of the cookie and/or the description of the cookie and/or classifying keywords.

19. Computer software product for administering cookies in an Internet client-server system according to claim 17 or 18,
characterised in that,
it adds to the second data set (22) of a cookie valid for a request made by a browser (12) a further data sub-set (24) having information for classification and protocolling of the request.

20. Computer software product for administering cookies in an Internet client-server system according to claim 19,
characterised in that,
it records in the added further data sub-set (24) at least the name and the Internet address of the HTML page directly called-up, on which page the object was found which initiated the request, and the time point of the call.

21. Computer software product for administering cookies in an Internet client-server system according to any of claims 17 to 20,
characterised in that,
it stores each cookie or a collection of a plurality of cookies in separate files in the client computer (11).

22. Computer software product for administering cookies in an Internet client-server system according to claim 21,
characterised in that,
it transfers these files to and from other computers, so that a client computer (11) has available a plurality of different cookies valid for one server computer address.

23. Computer software product for administering cookies in an Internet client-server system according to claim 21 or 22,
characterised in that,
it selects a cookie to be send back randomly from a plurality of cookies valid for this request.

24. Computer software product for administering cookies on a cookie server (19) of an Internet client-server system,
characterised in that,
it stores cookies, of the formats (20) according to any of claims 18 to 20, in a data bank of the cookie server, and
it makes is possible for computer software products according to claim 22 or 23 to feed arbitrary cookies into this data bank, to search for cookies in this data bank and to call up cookies out of this data bank.

25. Cookie server for administering cookies in an Internet client-server system,
characterised in that,
it has a data bank for storing cookies of the formats (20) according to any of claims 18 to 20, and it makes it possible for computer software products according to claim 22 or 23 to feed arbitrary cookies into this data bank, to search for cookies in this data bank and to call up cookies out of this data bank.

26. Client computer (11) for an Internet client-server system, having an interface device for data exchange via the Internet, at least one memory device (13) for storing data objects and an administration means for administering cookies, wherein
the administration means (14) sends a cookie stored in the memory device (13) back to the server computer (17) which placed the cookie, in dependence upon a preceding check.

27. Client computer (11) according to claim 26,
characterised in that,
the administration means (14) administers the cookies stored or to be stored in the memory device (13) independently of a browser (12) of the client computer which establishes an Internet connection to a server computer.

28. Client computer (11) according to claim 26 or 27,
characterised in that,
the administration means (14) undertakes a checking of the cookie in dependence upon configurable evaluation criteria in the client computer.

29. Client computer (11) according to any of claims 26 to 28,
characterised in that,
the administration means (14) determines the result of the checking of the cookie in dependence upon an evaluation of the server computer address attributable to this cookie as desired or undesired, directly called-up addresses being regarded as desired, indirectly called-up addresses as undesired.

30. Client computer (11) according to any of claims 26 to 29,
characterised in that,
the administration means (14) makes available a format (20) for storing a cookie in the memory device (13) having a first data set (21) with data fields for holding the original data of the cookie and a second data set (22) with data fields for holding additional data which serves for the checking of the cookie.

31. Client computer (11) according to claim 30, characterised in that, the administration means (14) make available in the second data set (22) a first data sub-set (23) having data fields for holding the creation date of the cookie and/or the designation of the cookie and/or the description of the cookie and/or classifying keywords.

32. Client computer (11) according to claim 30 or 31,
characterised in that,
the administration means (14) adds to the second data set (22) of a cookie valid for a request made by a browser (12) a further data sub-set (24) with information for classifying and protocolling the request.

33. Client computer (11) according to claim 32,
characterised in that,
the further data sub-set (24) added by the administration means (14) contain at least the name and the Internet address of the directly called-up HTML page on which the object was located which initiated the request, and the time point of the call.

34. Client computer (11) according to any of claims 30 to 33,
characterised in that,
the administration means (14) stores each cookie or a collection of a plurality of cookies in separate files in the memory device.

35. Client computer (11) according to claim 34,
characterised in that,
the administration means (14) transfer the files to at least one further computer and receives these files from at least one further computer, so that the client computer (11) has available a plurality of different cookies valid for one server computer address.

36. Client computer (11) according to claim 35,
characterised in that,
by means of the administration means (14) on different client computers (11) cookies from these client computers (11) can be stored in data banks of different Internet server computers (19) and therein can be searched for and called-up.

37. Client computer (11) according to claim 35 or 36,
characterised in that,
the administration means (14) randomly selects a cookie to be sent back from a collection of a plurality of cookies valid for this request.
